(19) United States
(12) Patent Application Publication
(10) Pub. No.: US 2003/0029806 A1
(43) Pub. Date: Feb. 13, 2003

(54) Canal restoration system and method

(76) Inventors: Charles H. Dickson, Yalaha, FL (US); Thomas A. Lovelace, Yalaha, FL (US)

Correspondence Address: Edward M. Livingston, Esq., 628 Ellen Dr., P.O. Box 1599, Winter Park, FL, 32790, US

(21) Appl. No.: 09/915,451

(22) Filed: Jul. 26, 2001

(51) Int. Cl. E02B 15/00; C02F 1/00

(52) U.S. Cl. 210/747; 210/170

(57) ABSTRACT

A canal-restoration system and method has a processor tank (1) that includes a screen (5) vertically above a soil accumulator (6) and vertically below a water collector (4) near a top portion of the processor tank. Waterway sludge pumped from canals is conveyed downward in a sludge inlet (7) onto a disperser (14) and into the soil accumulator. Below the sludge inlet, soil (15) in the waterway sludge settles downwardly for dump or conveyance removal. Also, below the sludge inlet, settled water (16) circulates upwardly through the screen to the water collector at a top portion of the processor tank for conveyance back to the canals as screened-clear water (17). The screen preferably has upwardly progressive fineness of a plurality of three or more screens. A downward settling action keeps the screen unclogged and easily cleaned.

### BACKGROUND OF THE INVENTION

This invention relates to restoration of canals by removal of sludge and debris that accumulates gradually to the extent that such canals become unusable, particularly in low-water conditions caused by droughts.

Canal restoration systems and devices which separate waterway sludge into usable soil and water are known, but not with a high level of efficiency and economy of up-draft screening, settling, soil handling and water hydraulics taught by this invention. Examples of most-closely related known but different devices are described in the following patent documents:

| U.S. Pat. No. | Inventor | Issue Date |
|---|---|---|
| 4,807,373 | Sloan, et al. | 02/28/1989 |
| 4,854,058 | Sloan, et al. | 08/08/1989 |
| 4,975,205 | Sloan | 12/04/1990 |
| 5,021,156 | Sloan | 06/04/1991 |
| 5,115,751 | Copson | 05/26/1992 |
| 4,436,622 | Petretti | 03/13/1984 |
| 1,331,239 | Cartwright | 02/17/1920 |
| 1,166,713 | Otterson | 01/04/1916 |
| 1,344,710 | Otterson | 06/29/1920 |
| 3,463,172 | Naylor | 08/26/1969 |
| 5,234,309 | Foster | 08/10/1993 |
| 4,929,353 | Harris | 05/29/1990 |
| 2,753,877 | McKnight | 07/10/1956 |
| 3,013,665 | Schmidt, et al. | 12/19/1961 |
| 3,262,571 | Petretti | 07/26/1966 |
| 3,317,049 | Petretti | 05/02/1967 |
| 4,389,314 | Petretti | 01/21/1983 |
| 5,167,841 | Mims | 12/01/1992 |
| 5,707,535 | Harris | 01/13/1998 |
| 5,295,317 | Perrott | 03/22/1994 |
| 5,647,691 | Wirth | 07/15/1997 |

### SUMMARY OF THE INVENTION

Objects of patentable novelty and utility taught by this invention are to provide a canal restoration system and method which:

eco-compatibly and economically rids canals of use-obstructive accumulation of sludge and debris;

places the sludge where it can be conveyed economically and conveniently to either near or remote sites; and

economically and conveniently separates the debris from the sludge and the canal water.

This invention accomplishes these and other objectives with a canal-restoration system and method having a sludge-processor that is mobile so it can be located proximate banks of canals. The sludge processor includes an up-flow screen near a top portion of a processor tank. Sludge pumped from the canals is conveyed preferably downward through a pipe against a dispenser into a processor tank under the up-flow screen. The sludge earth settles downwardly in the collection tank for dump or conveyor-belt removal, while the sludge water circulates upwardly through the up-flow screen to a top portion of the processor tank for conveyance back to the canals. The up-flow screen preferably has upwardly progressive fineness of a plurality of three or more screens. A settling action keeps the up-flow screen unclogged.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a partially cutaway side view of a dump-bed embodiment with a residual tank inside of a bottom front of a processor tank and having one or more collector tubes in fluid communication from a water collector above a screen;

FIG. 2 is a partially cutaway top view of the FIG. 1 illustration;

FIG. 3 is a partially cutaway top view of a dump-bed embodiment with a residual tank outside of a bottom front of the dump bed and having a collector tube in fluid communication from a horizontal channel at the water collector above the screen;

FIG. 4 is a partially cutaway side view of the FIG. 3 illustration;

FIG. 5 is a partially cutaway front view of a dump-bed embodiment as seen from section line 1-1 of FIG. 1 to show a residual tank inside of a bottom front of the dump bed and having a collector tube in fluid communication from the horizontal channel at the water collector to the residual tank

FIG. 6 is a partially cutaway front view of the FIG. 3 illustration taken from section line 3-3 of FIG. 3.

FIG. 7 is a partially cutaway side view of a dump-bed embodiment having a return tank adjacent to a processor tank inside of a front of the dump bed;

FIG. 8 is a partially cutaway front view of the FIG. 7 illustration from section line 7-7 of FIG. 7;

FIG. 9 is a partially cutaway side view of a screw-conveyor embodiment with a residual tank under a bottom front of a processor tank and having one or more collector tubes in fluid communication from the water collector above the screen;

FIG. 10 is a partially cutaway front view of the FIG. 9 illustration from section line 9-9 of FIG. 9;

FIG. 11 is a partially cutaway side view of a conveyor-belt embodiment with the residual tank under a bottom front of the processor tank and having one or more collector tubes in fluid communication from the water collector above the screen;

FIG. 12 is a partially cutaway front view of the FIG. 11 illustration from section line 11-11 of FIG. 11;

FIG. 13 is a partially cutaway exploded side view of opposite ends of a conveyor belt of the FIGS. 11-12 illustrations; and

FIG. 14 is a partially cutaway exploded end view of the conveyor belt of the FIGS. 11-12 illustrations.

### DESCRIPTION OF PREFERRED EMBODIMENT

Listed numerically below with reference to the drawings are terms used to describe features of this invention. These terms and numbers assigned to them designate the same features throughout this description.

| | |
|---|---|
| 1. | Processor tank |
| 2. | Tank walls |
| 3. | Tank bottom |
| 4. | Water collector |
| 5. | Screen |
| 6. | Soil accumulator |
| 7. | Sludge inlet |
| 8. | Collector tube |
| 9. | Water-return conveyance |
| 10. | Sludge tube |
| 11. | Inside residual tank |
| 12. | Residual conveyances |
| 13. | Discharge gate |
| 14. | Sludge disperser |
| 15. | Soil |
| 16. | Settled water |
| 17. | Screened-clear water |
| 18. | Outside residual tank |
| 19. | Drain wall |
| 20. | Tube inlet |
| 21. | Return tank |
| 22. | Return-tank wall |
| 23. | Return-tank bottom |
| 24. | Return-water conveyance |
| 25. | Trapdoor outlet |
| 26. | Discharge aperture |
| 27. | Water-return end |
| 28. | Soil-discharge end |
| 29. | Funnel-channeled walls |
| 30. | Water return |
| 31. | Flexible tube |
| 32. | Conveyor screw |
| 33. | Conveyor belt |
| 34. | Gear motor |
| 35. | Conveyor-screw nozzle |
| 36. | Conveyor-belt nozzle |
| 37. | Arcuate channel |
| 38. | Orthogonal channel |
| 39. | Residual conveyance |
| 40. | Drain orifices |
| 41. | Residual valve |
| 42. | Return-water connection |

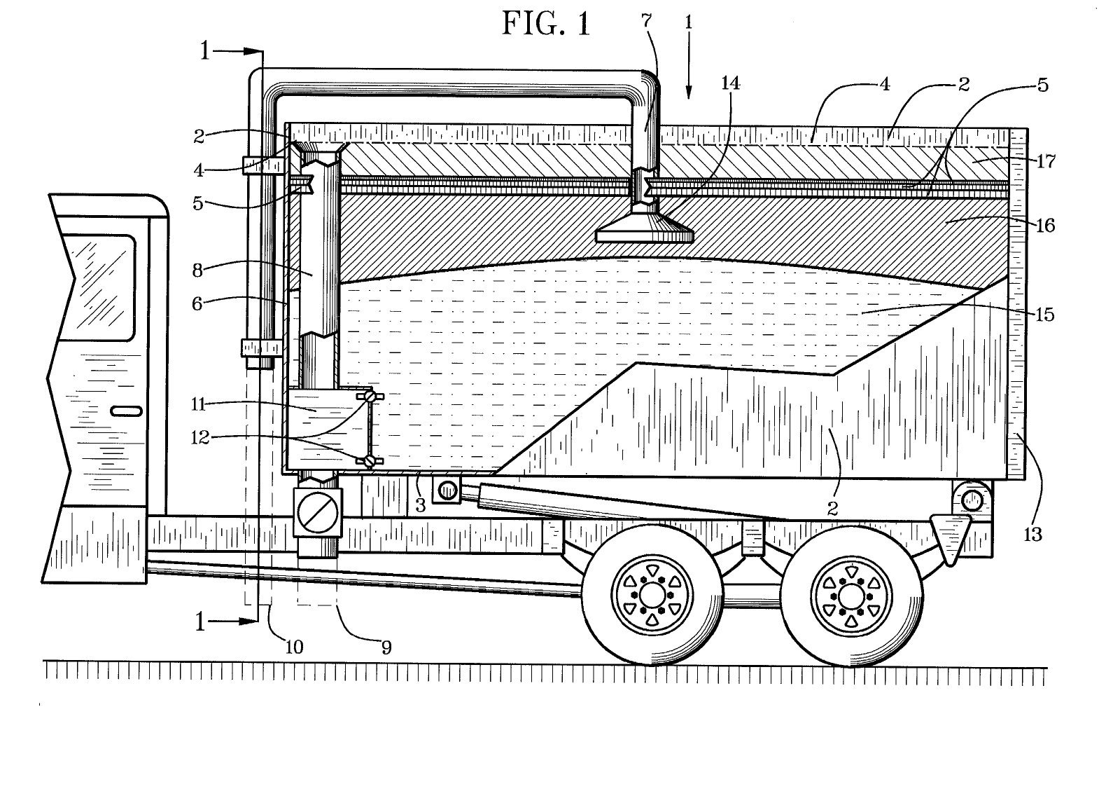

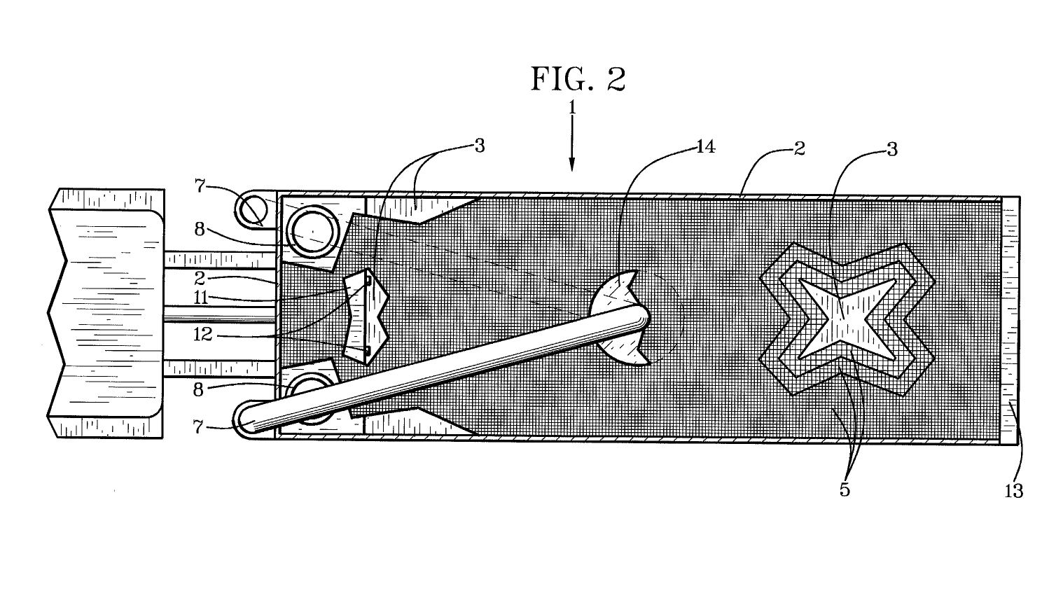

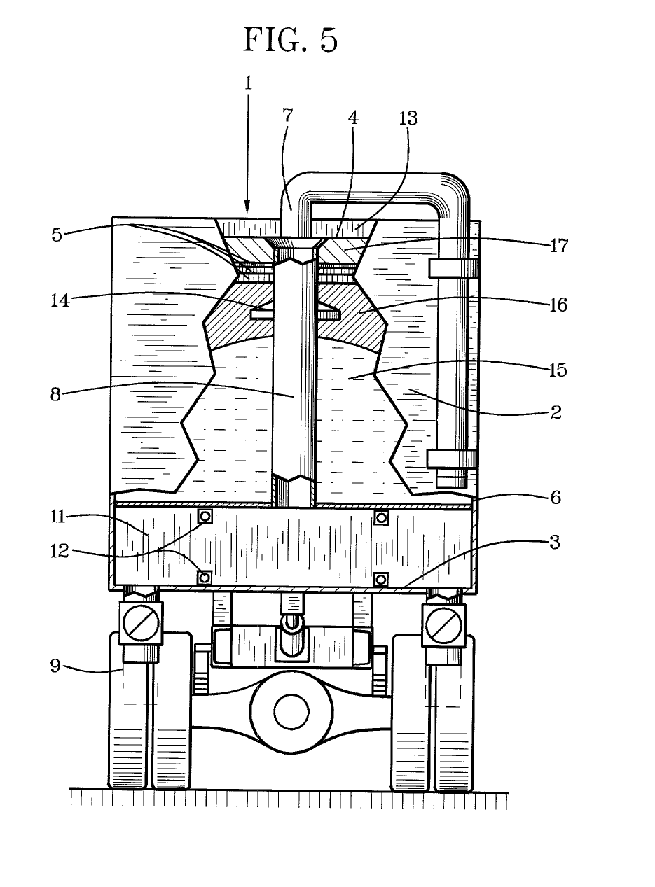

Referring to FIGS. 1-2 and 5, a canal-restoration system has a sludge processor which can be a batch-dump processor or a batch-conveyance processor, either of which are mobile proximate banks of waterways for separating waterway sludge from water in canals and other waterways. Generally, the sludge is highly fertile soil from long accumulation and settling of organic matter as in river bottoms. Also as in river bottoms, the soil is relatively sandy and loamy instead of muddy, slimy or viscose. The soil settles when stirred, pumped or piped and can be strained readily for clear processing.

Canal restoration with this invention is a process of separating the soil from water of waterway sludge with the sludge processor, returning relatively clear water to the canal or waterway and disposing of the soil as desired for fertile buildup of land nearby or remotely.

The sludge processor includes a processor tank 1 having tank walls 2 and a tank bottom 3 with internal peripheries. Intermediate the internal peripheries of a top portion of the tank walls 2 is a water collector 4. Vertically below the water collector 4 intermediate the internal peripheries of the tank walls 2 is a screen 5. Downward vertically intermediate the screen 5 and the tank bottom 3 and intermediate the tank walls 2 is a soil accumulator 6.

From either side of the processor tank 1, a sludge inlet 7 conveys waterway sludge downward vertically through the screen 5 to the soil accumulator 6. A water return, which can include one or more collector tubes 8, is in fluid communication from the water collector 4 to a desired water-return conveyance 9 shown partially in dashed lines. The sludge inlet 7 can be in fluid communication with a desired sludge source which can include a sludge tube 10 shown in dashed lines from a sludge pump that is not shown.

An inside residual tank 11 can be situated proximate a bottom of the one or more collector tubes 8 and provided with one or more residual conveyances 12 in predeterminedly valved fluid communication intermediate the residual tank 11 and the soil accumulator 6. The inside residual tank 11 is inside an end of the soil accumulator 6 that is oppositely disposed from a soil discharge which can include a discharge gate 13 that can be hinged horizontally or vertically.

A method for using this canal-restoration system includes steps of situating the water collector 4 proximate a water-collection portion of the tops of the interior peripheries of the tank walls 2 of the processor tank 1 that is mobile proximate banks of waterways that include canals.

A screen 5 that preferably includes progressively fine screening passage upwardly intermediate a bottom and a top of the screen 5 is provided for up-flow screening of water that is settled in the soil accumulator 6.

The up-flow screening is achieved by pumping waterway sludge through the sludge inlet 7 and downwardly through the screen 5 to the soil accumulator 6 where the waterway sludge can be dispersed with a sludge disperser 14 for scattering it evenly and minimizing disturbance of settling in the soil accumulator 6. Filling the processor tank 1 to a fullness height that is proximate the water collector 4 and a top of a water return that can include the collector tubes 8 allows settling of soil 15 as sediment from settled water 16 that then circulates upwardly through the screen 5 to become screened-clear water 17 that is overflow-discharged to water-return conveyances 9.

The screened-clear water 17 is returned to a desired waterway and the soil 15 is utilized nearby or remotely.

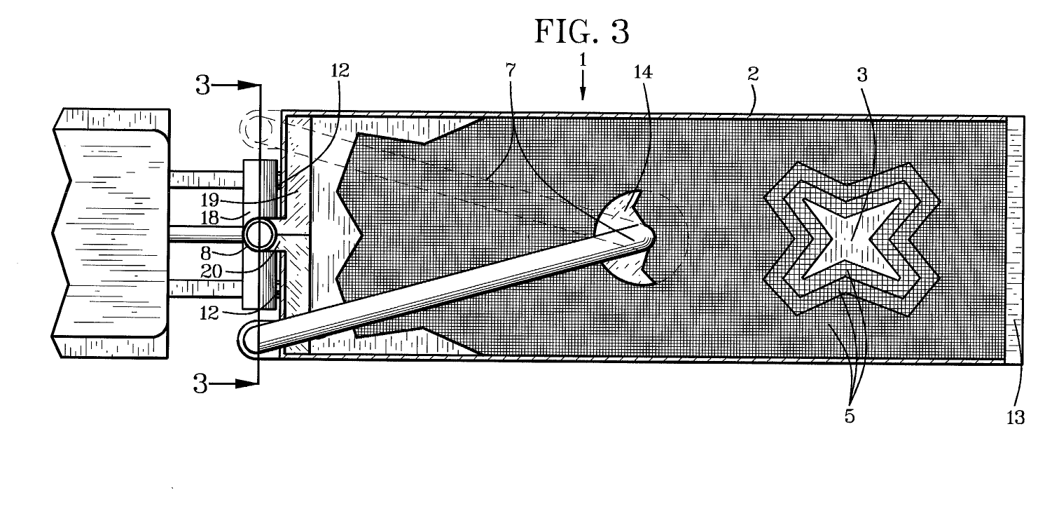

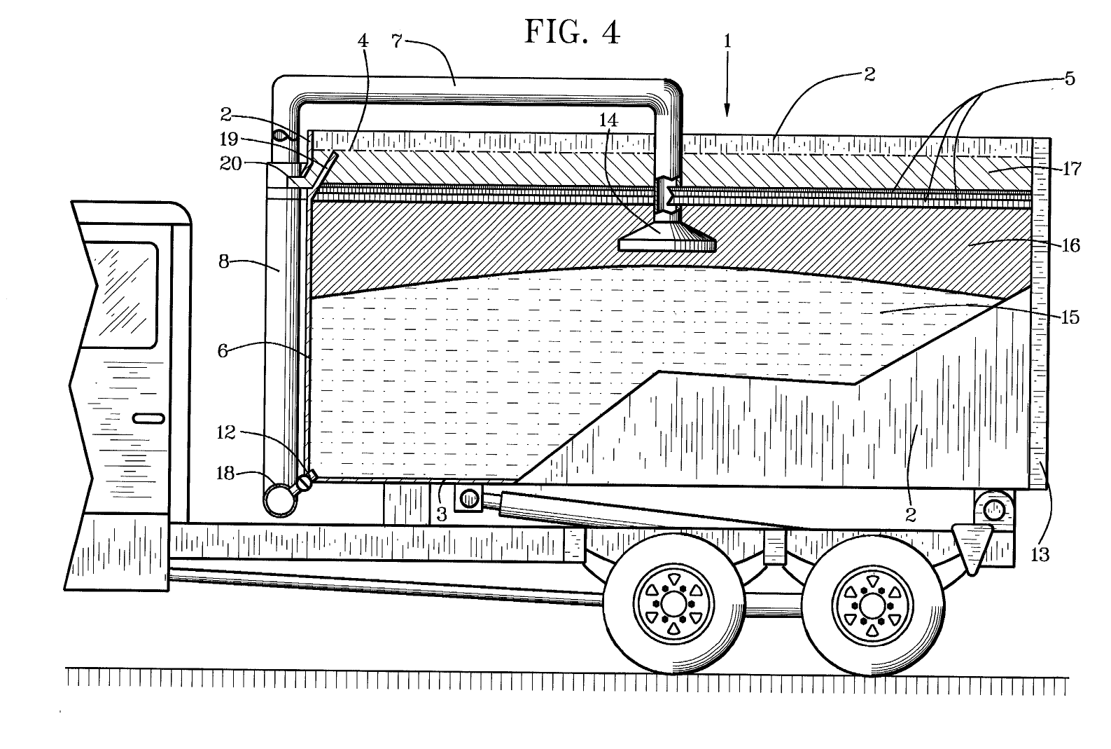

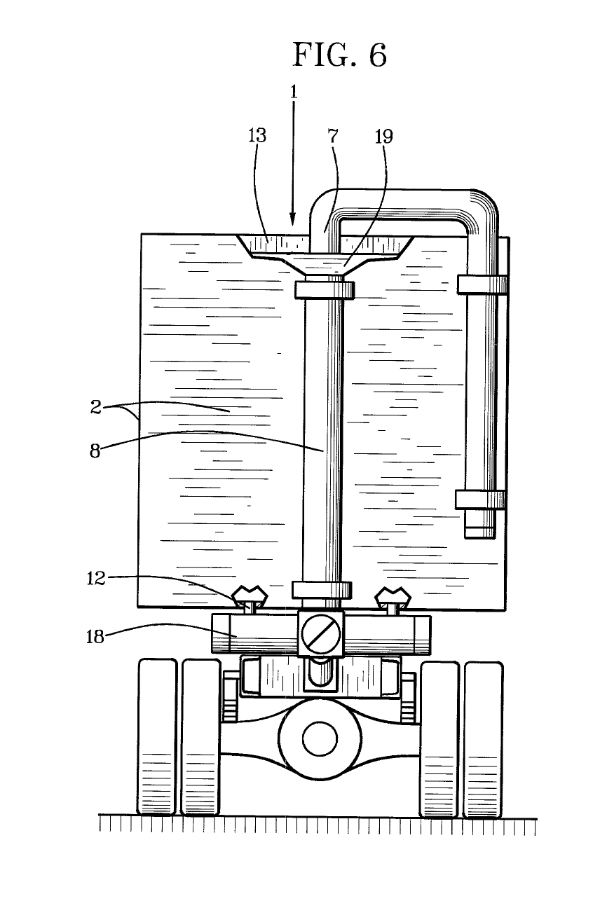

Referring to FIGS. 3-4 and 6, an outside residual tank 18 can be situated proximate a bottom of the one or more collector tubes 8 that can be outside of the processor tank 1 and provided with one or more of the residual conveyances 12 in predeterminedly valved fluid communication intermediate the outside residual tank 18 and the soil accumulator 6. A drain wall 19 can be slanted downwardly from a water level of the screened-clear water 17 to tube inlets 20 to the collector tube 8 for the outside residual tank 18. As appropriate for dump-bed and conveyor embodiments of this invention, the residual conveyances 12 can be two-way-valved for either (a) preventing out flow of the settled water 16 during discharge of screened-clear water 17, (b) allowing drain-off of the settled water 16 after completion of discharge of the screened-clear water 17 when a load of soil 15 has been accumulated and (c) allowing flow of the settled water 16 back into the soil accumulator 6 for flushing action after being dumped. The residual conveyances 12 are referred to also as clean-out conveyances or drain conveyances accordingly.

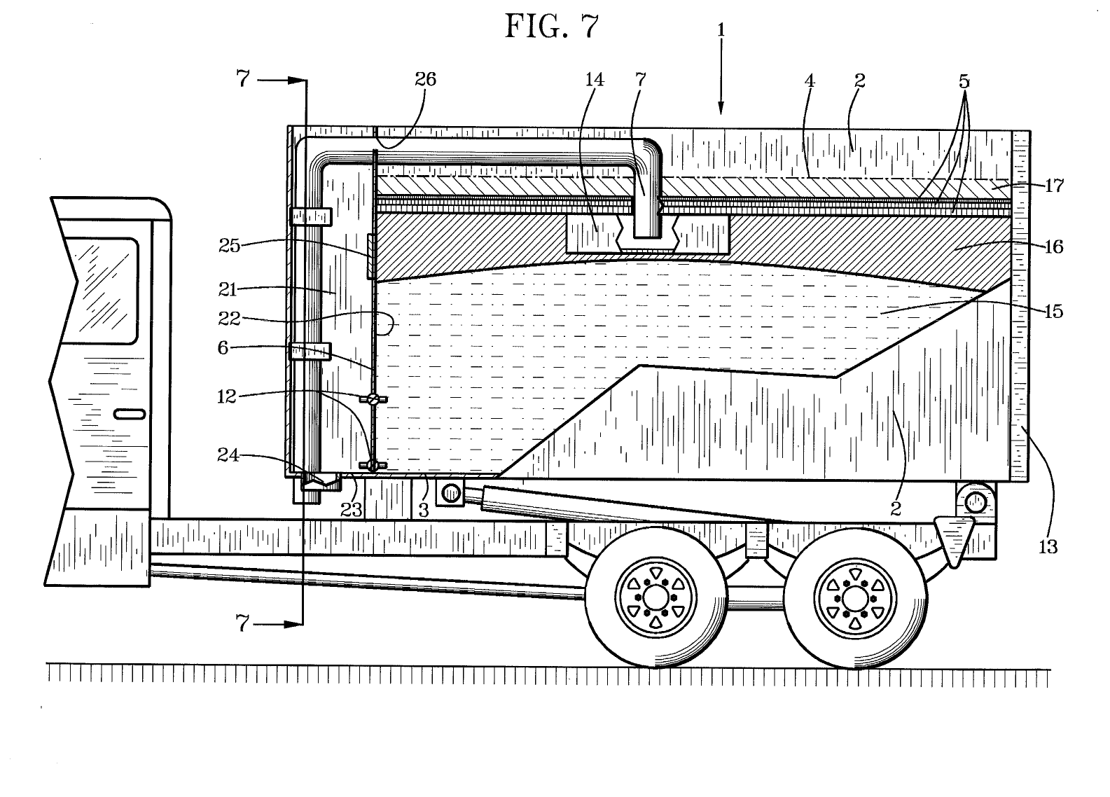

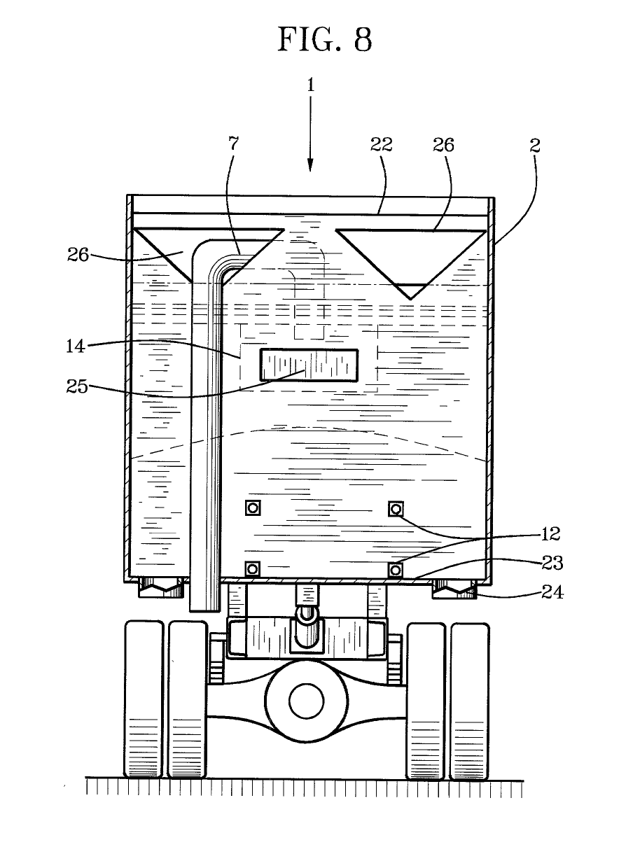

Referring to FIGS. 7-8, the batch-dump processor can include a return tank 21 adjacent to the processor tank 1 and have a return-tank wall 22 and a return-tank bottom 23 on a front end of the dump bed that is opposite the discharge gate 13 at a dump-gate end. The return tank 21 can have at least one return-water conveyance 24 in fluid communication from the return tank 21. A trapdoor outlet 25 and residual conveyances 12 can aid in discharge of screened-clear water 17 from the soil accumulator 6 into the return tank 21 for discharge through the water-return conveyance 24. The sludge dispenser 14 can be rectangular or circular. The sludge inlet 7 can be routed upward vertically through the return tank 21 and into the soil accumulator 6 through discharge apertures 26 in the return-tank wall 22.

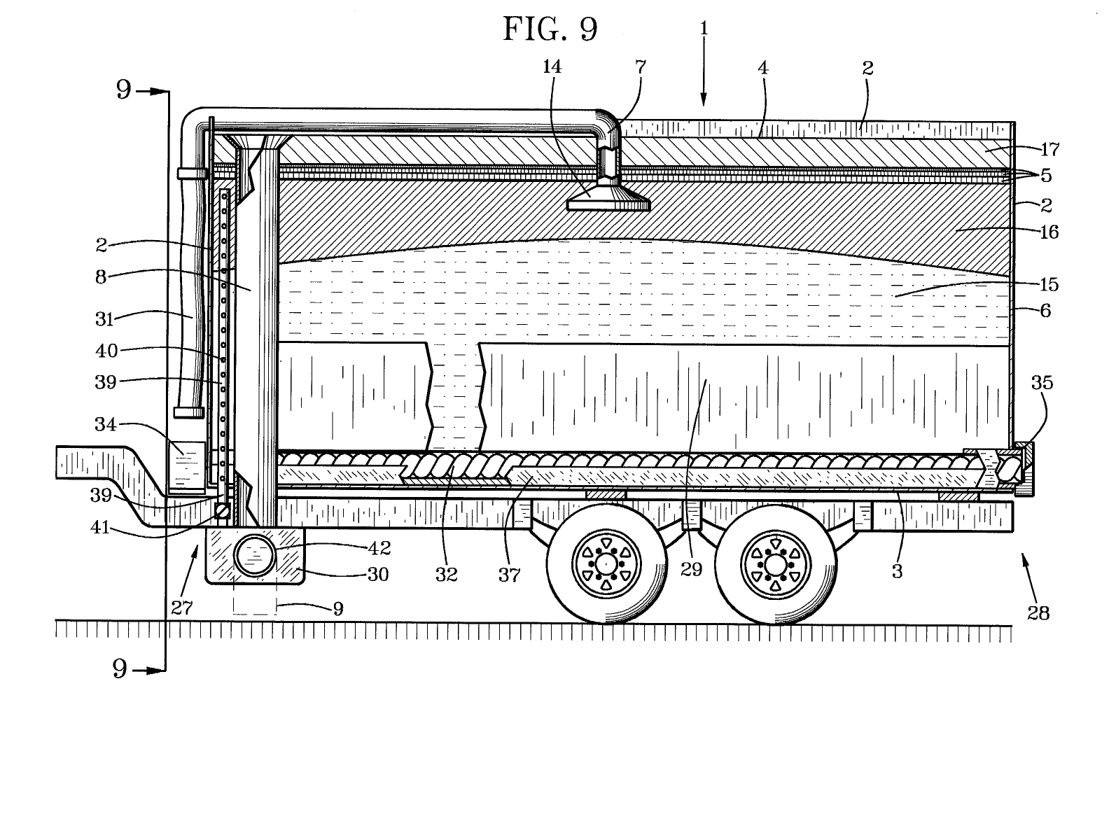

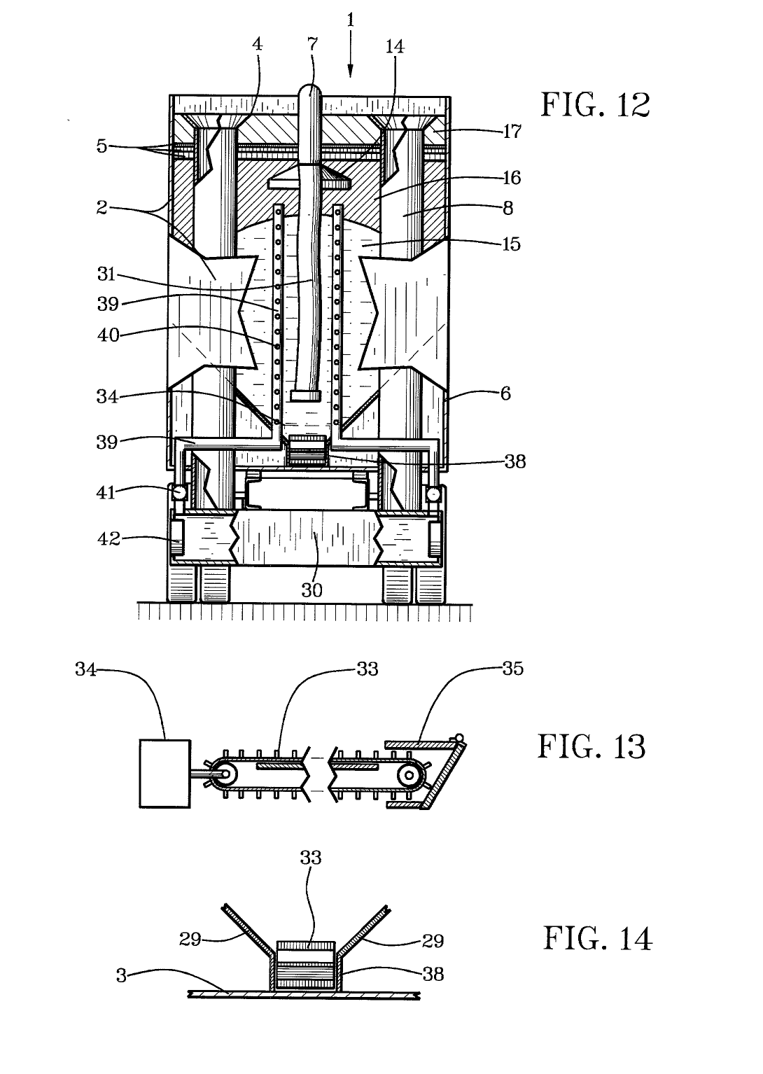

Referring to FIGS. 9-12, the batch-conveyance processor can include a soil conveyor in soil-conveyance communication intermediate a water-return end 27 and a soil-discharge end 28 of the soil accumulator 6. The tank bottom 3 can include funnel-channeled walls 29 with centrally downward slanting surfaces having predetermined steepness for causing gravitation-induced central travel of the soil 15 in the soil accumulator 6. The soil conveyor is situated between the funnel-channeled walls 29 for efficient and settling-compatible conveyance of the soil 15 to proximate the soil-discharge end 28.

The water collector 4 includes a water-collection conveyance that can be the collector tube 8 intermediate the top portion of the processor tank 1 and a water return 30 proximate a bottom of the processor tank 1. The water return 30 is attachable to the water-return conveyance 9 for discharge of screened-clear water 17 that has circulated upwardly through the screen 5 as settled water 16. The waterway sludge can be pumped to the sludge inlet 7 through a flexible tube 31 or a pivotal rigid tube that can be swung to either side of the processor tank 1 to obviate need to connect it to a different side of the processor tank 1 for connection to a sludge pump at either side.

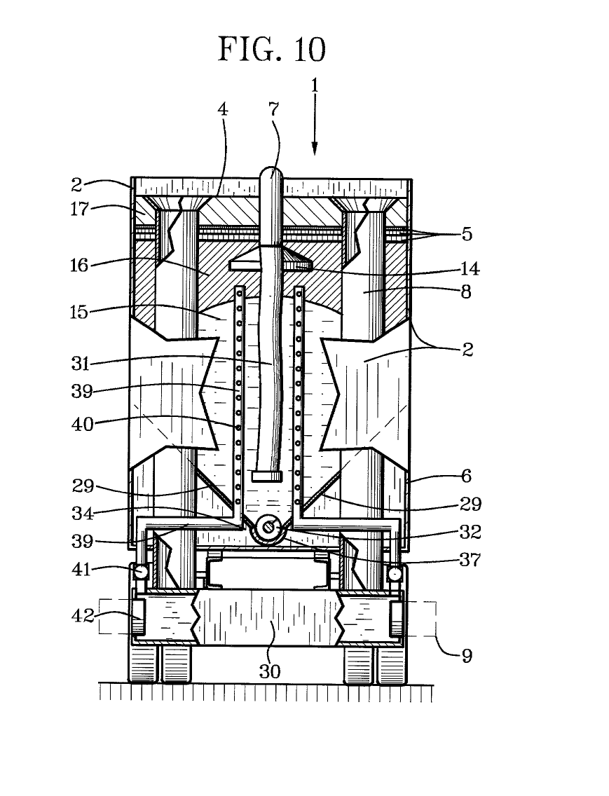

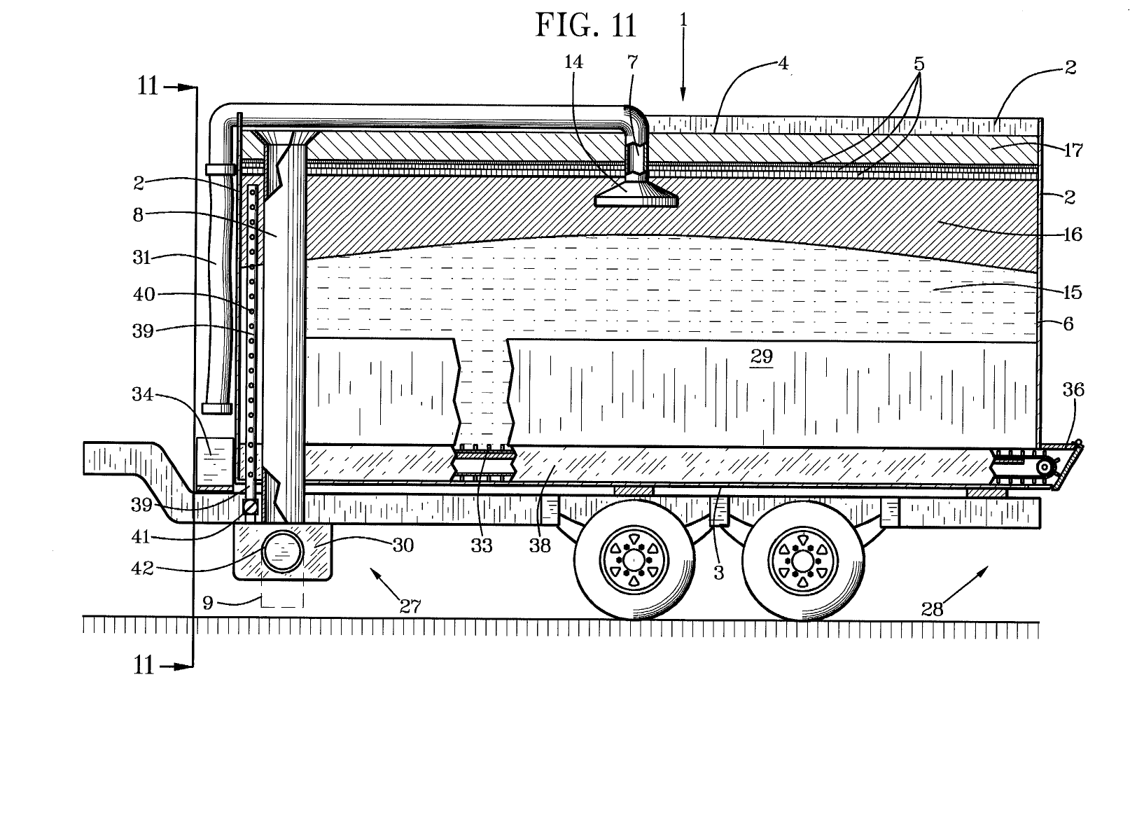

Optionally, the soil conveyor can be a conveyor screw 32 as illustrated in FIGS. 9-10 or a conveyor belt 33 as illustrated in FIGS. 11-14. Either can be gear-motorized with a gear motor 34 where and as appropriate and provided with a conveyor nozzle at the soil-discharge end 28.

The conveyor nozzle can be a conveyor-screw nozzle 35 as shown in FIG. 9 or a conveyor-belt nozzle 36 as shown in FIG. 11. Either can be used to discharge the soil 15 variously. Included can be directing the soil under the conveyor-screw nozzle 35 or the conveyor-belt nozzle 36 for its sacking, spreading distribution or further motorized conveyance to trucks or other vehicles. Also, either can be provided with an appropriate cover or cap when not in use.

The conveyor screw 32 is nested linearly in an arcuate channel 37 and the conveyor belt 33 is nested linearly in an orthogonal channel 38 between the funnel-channeled walls 29.

One or more residual conveyances 39 in predeterminedly valved fluid communication are provided intermediate the soil accumulator 6 and the water return 30. The residual conveyances 39 have drain orifices 40. The residual conveyances 39 are preferably routed and extended to pass through the soil 15 to the settled water 16 in the soil accumulator 6 for draining residual water after consecutive fillings of the soil accumulator 6 with the soil 15. A residual valve 41 in the one or more residual conveyances 39 can be closed to prevent settled-water-16 bypass of the screen 5 while the waterway sludge is being settled and screened.

The water return 30 is preferably under the processor tank 1 where a return-water connection 42 can be utilized simultaneously with the flexible tube 31 for processing the waterway sludge.

A new and useful canal-restoration system and method having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A canal-restoration system comprising:
a sludge processor that is mobile proximate banks of waterways;
the sludge processor including a processor tank having tank walls and a tank bottom with internal peripheries;
a water collector intermediate the internal peripheries of the tank walls of proximately a top portion of the processor tank;
a screen vertically below the water collector intermediate the internal peripheries of the tank walls;
a soil accumulator vertically intermediate the screen and the tank bottom and horizontally intermediate the internal peripheries of the tank walls;
a sludge inlet having conveyance of waterway sludge to the soil accumulator in sludge-fluid communication vertically downward through the screen;
a water return in fluid communication with the water collector; and
a soil discharge in soil-discharge communication with the soil accumulator.

2. The canal-restoration system of claim 1 wherein:
the sludge processor is a batch-dump processor;
the soil accumulator is a batch-load accumulator of soil for accumulating batch loads of soil; and
the soil discharge is a batch-load discharger for discharging the batch loads of soil repetitively after the batch loads of soil are accumulated from settling under the screen and from being screened from upward travel through the screen with circulation of partially processed sludge.

3. The canal-restoration system of claim 1 wherein:
the sludge processor is a batch-conveyance processor;
the soil accumulator is a funnel-channeled accumulator of soil; and
the soil discharge is a conveyor for discharging the soil intermittently as accumulated from settling under the screen and from being screened from upward travel through the screen with circulation of partially processed sludge.

4. The canal-restoration system of claim 1 wherein:
the screen includes progressively fine screening passage upwardly intermediate a bottom of the screen and a top of the screen.

5. A canal-restoration system comprising:
a batch-dump processor that is mobile proximate banks of waterways;
the batch-dump processor including a processor tank having tank walls and a tank bottom with internal peripheries;
the processor tank including a dump bed on predetermined mobility wheels;
a water collector intermediate the internal peripheries of the tank walls of proximately a top portion of the processor tank;
the water collector including a water-collection conveyance intermediate the top portion of the processor tank and a water return proximate a bottom of the processor tank;
a screen vertically below the water collector intermediate the internal peripheries of the tank walls;
a soil accumulator vertically intermediate the screen and the tank bottom and horizontally intermediate the internal peripheries of the tank walls;
a sludge inlet having conveyance of waterway sludge to the soil accumulator in sludge-fluid communication vertically downward through the screen;
the sludge inlet includes one or more tubular conveyances which are extended from the sludge inlet through the screen in communication of the sludge inlet with the soil accumulator;
the water return being attachable to a return-water conveyance having predetermined conveyance of the return water from the water collector;
a sludge source in sludge-fluid communication with the sludge inlet;
the sludge source including a sludge tube that is attachable to a predetermined sludge pump;
a soil discharge in soil-discharge communication with the soil accumulator; and
the soil discharge includes a discharge gate on an outlet end of the dump bed.

6. The canal-restoration system of claim 5 wherein:
the screen includes progressively fine screening passage upwardly intermediate a bottom of the screen and a top of the screen.

7. The canal-restoration system of claim 5 wherein:
the water-collection conveyance includes one or more collector tubes proximate an opposite end of the dump bed from the discharge gate.

8. The canal-restoration system of claim 7 wherein:
the one or more collector tubes are in the dump bed.

9. The canal-restoration system of claim 7 wherein:
the one or more collector tubes are proximate an outside periphery of the tank walls.

10. The canal-restoration system of claim 7 and further comprising:
a residual tank proximate a bottom of the one or more collector tubes; and
one or more residual conveyances in predeterminedly valved fluid communication intermediate the soil accumulator and the residual tank.

11. The canal-restoration system of claim 10 and further comprising:
one or more clean-out conveyances in predeterminedly valved fluid communication intermediate the residual tank and the soil accumulator.

12. The canal-restoration system of claim 7 and further comprising:
the residual tank proximate the bottom of the one or more collector tubes; and
one or more two-way conveyances in predeterminedly two-way-valved fluid communication intermediate the soil accumulator and the residual tank to drain residual water from the soil into the residual tank for return disposition and for utilizing at least a portion of the residual water for cleaning the bottom of the processor tank when being emptied.

13. The canal-restoration system of claim 5 wherein:
the water-collection conveyance includes a portion of the dump bed that is separated from the soil accumulator by a processor-tank wall proximate an opposite end of the dump bed from the discharge gate.

14. A canal-restoration system comprising:
a batch-dump processor that is mobile proximate banks of waterways;
the batch-dump processor including a processor tank having tank walls and a tank bottom with internal peripheries;
the batch-dump processor including a return tank adjacent to the processor tank and having return-tank walls and a return-tank bottom;
the processor tank and the return tank being on a dump bed with predetermined mobility wheels;
the return tank being proximate an end of the processor tank that is oppositely disposed from a dump-gate end of the processor tank;
a water collector that is disposed predeterminedly horizontal intermediate the internal peripheries of the tank walls of proximately a top portion of the processor tank;
the water collector including a water-collection conveyance intermediate the top portion of the processor tank and the return tank;
a screen vertically below the water collector intermediate the internal peripheries of the tank walls;
a soil accumulator vertically intermediate the screen and the tank bottom;
a sludge inlet having conveyance of waterway sludge to the soil accumulator in sludge-fluid communication vertically downward through the screen;
the sludge inlet includes one or more tubular conveyances which are extended from the sludge inlet through the screen in communication of the sludge inlet with the soil accumulator;
at least one return-water conveyance having predetermined conveyance of return water from the return tank;
a sludge source in sludge-fluid communication with the sludge inlet;
the sludge source including a sludge tube that is attachable to a predetermined sludge pump;
a soil discharge in soil-discharge communication with the soil accumulator; and
the soil discharge includes a discharge gate on the dump-gate end of the dump bed.

15. The canal-restoration system of claim 14 wherein:
the screen includes progressively fine screening passage upwardly intermediate a bottom of the screen and a top of the screen.

16. The canal-restoration system of claim 14 and further comprising:
one or more drain conveyances in predeterminedly valved fluid communication intermediate the soil accumulator and the return tank.

17. The canal-restoration system of claim 14 and further comprising:
one or more clean-out conveyances in predeterminedly valved fluid communication intermediate the return tank and the soil accumulator.

18. The canal-restoration system of claim 14 and further comprising:
one or more two-way conveyances in predeterminedly two-way-valved fluid communication intermediate the soil accumulator and the return tank to drain residual water from the soil into the return tank for return disposition and for utilizing at least a portion of the residual water for cleaning the bottom of the processor tank when being emptied.

19. A canal-restoration system comprising:
a batch-conveyance processor that is mobile proximate banks of waterways;
the batch-conveyance processor including a processor tank having tank walls and a tank bottom with internal peripheries;
a water collector intermediate the internal peripheries of the tank walls of proximately a top portion of the processor tank;
the water collector including a water-collection conveyance intermediate the top portion of the processor tank and a water return proximate a bottom of the processor tank;
a screen vertically below the water collector intermediate the internal peripheries of the tank walls;
a soil accumulator vertically intermediate the screen and the tank bottom and horizontally intermediate the internal peripheries of the tank walls;
a sludge inlet having conveyance of waterway sludge to the soil accumulator in sludge-fluid communication vertically downward through the screen;
the sludge inlet includes one or more tubular conveyances which are extended from the sludge inlet through the screen in communication of the sludge inlet with the soil accumulator;
the water return being attachable to a return-water conveyance having predetermined conveyance of the return water from the water collector;
the water return being proximate a water-return end of the soil accumulator that is oppositely disposed from a discharge end of the soil accumulator;
a sludge source in sludge-fluid communication with the sludge inlet;
the sludge source including a sludge tube that is attachable to a predetermined sludge pump;
a soil conveyor in soil-conveyance communication intermediate the water-return end and the discharge end of the soil accumulator; and
a soil discharge in soil-discharge communication with the discharge end of the soil accumulator.

20. The canal-restoration system of claim 19 wherein:
the screen includes progressively fine screening passage upwardly intermediate a bottom of the screen and a top of the screen.

21. The canal-restoration system of claim 19 wherein:
the tank bottom includes funnel-channeled walls with centrally downward slanting surfaces having predetermined steepness for causing gravitation-induced central travel of the soil in the soil accumulator; and
the soil conveyor is situated between bottoms of the funneled-channeled walls for conveyance of the soil to proximate the soil-discharge end.

22. The canal-restoration system of claim 21 wherein:
the soil conveyor includes a conveyor screw.

23. The canal-restoration system of claim 21 wherein:
the soil conveyor includes a conveyor belt.

24. The canal-restoration system of claim 21 wherein:
the soil discharge includes a conveyor nozzle.

25. The canal-restoration system of claim 19 wherein:
the water-collection conveyance includes one or more collector tubes.

26. The canal-restoration system of claim 25 and further comprising:
a water return proximate a bottom of the one or more collector tubes; and
one or more residual conveyances in predeterminedly valved fluid communication intermediate the soil accumulator and the residual tank.

27. The canal-restoration system of claim 26 and further comprising:
the one or more residual conveyances have drain orifices for entry of residual settled water.

28. A canal-restoration method comprising the following steps:
providing a processor tank on a sludge processor that is mobile proximate banks of waterways;
situating a water collector proximate a water-collection portion of a top of interior peripheries of walls of the processor tank;
placing a screen vertically lower than the water collector intermediate the interior peripheries of the tank walls of the processor tank;
providing a soil accumulator vertically under the screen;
providing a sludge inlet for conveying waterway sludge downwardly through the screen to the soil accumulator under the screen;
filling the processor tank to a fullness height that is proximate the water collector in order to cause the waterway sludge to settle-deposit a portion of soil contained in the sludge in the soil accumulator while also causing the waterway sludge to circulate upwardly through the screen for screening out soil that has not been settle-deposited in the soil accumulator;
discharging screened-clear water from the water collector; and
discharging the soil from the soil accumulator.

29. The canal-restoration method of claim 28 wherein:
the screen includes progressively fine screening passage upwardly intermediate a bottom of the screen and a top of the screen.
